(19) United States
(12) Patent Application Publication
(10) Pub. No.: US 2025/0087665 A1
(43) Pub. Date: Mar. 13, 2025

(54) STRUCTURE FOR IMPROVED ELECTRODE

(71) Applicant: TAIWAN MAXWAVE CO., LTD., Taipei City (TW)

(72) Inventors: FON SHIN YU, Taipei City (TW); TSONG MING CHANG, Taipei City (TW); CHIH HUNG CHEN, Taoyuan City (TW)

(21) Appl. No.: 18/367,613

(22) Filed: Sep. 13, 2023

(51) Int. Cl. H01M 4/134; H01M 4/60; H01M 4/62; H01M 10/0569

(52) U.S. Cl. CPC H01M 4/134; H01M 4/602; H01M 4/624; H01M 10/0569

(57) ABSTRACT

The present utility model relates generally to an improved electrode structure, comprising of: an electrode material, and the electrode material has weight percentage of 80-96%; an electrically conductive material, and the electrically conductive material has weight percentage of 2-10%; an adhesive, and the adhesive has a weight percentage of 2-10%; a low toxicity and environmentally friendly solvent, and the low toxicity environmentally friendly solvent has weight percentage of 20-70% in positive electrode material, and 100-150% in negative electrode material; wherein the improved electrode structure was given with treatment of baking temperature of 50-150° C., with process time of 8 to 12 hours.

### BACKGROUND OF THE INVENTION

### Field of the Invention

This patent relates to technical field of battery, and it also relates to a solvent of low toxicity, low odor and low boiling point and a structure of preparing Li battery electrode using the solvent. Low toxicity environmentally friendly solvent is of high safety to human body and environment, and it can take care of environmental protection and maintain the long term effectiveness of Li ion battery as well, in other words, it is an improved electrode structure.

### Prior Art

Presently, about 90% of positive electrode adhesive uses oil-based adhesive PVDF (polyvinylidene difluoride), however, the matching solvent of PVDF, NMP(N-methyl-pyrrolidon), has the risk of reproductive toxicity, and in European Union, related policies have been proposed to limit the use of NMP; meanwhile, due to the shortage in its supply, NMP, starting from the second half of 2021, it's price is rising all the way; presently, the domestic product price is about 450-500 thousand NT dollars/ton, and the importing product price is as high as 700-800 thousand NT dollars; in addition, thermal decomposition of NMP will lead to the generation of irritating or toxic gas, which is harmful and toxic to the environment and human body; therefore, in the recycling process, it is needed to have extra solvent recycling system; therefore, when it is applied in the battery, it will raise the cost more, consequently, the material industry and battery industry are trying to develop aggressively slurry solvent of positive electrode of Li battery of lower cost, more environmental friendly and high performance to replace NMP. Therefore, more people focus on improving the processes of environmentally friendly production, however, when water-based adhesive is used in ternary material system, it could easily generate alkaline compound with ternary metals, and it could further corrode the Aluminum electrode to affect the battery capacity, therefore, there is no better solution presently. Therefore, based on the development direction of solvent, it can roughly be divided into solvent not containing sulfur functional group, or the change of solvent with cyclic structure into solvent of open loop structure. Along with the revision of chemical safety act and regulation, how to select low toxicity environmentally friendly solvent appropriately in order to enhance the safety of Li battery and to take care of good battery performance as well is the focus of this patent, and it is the most difficult part too.

Due to the difficulty of solving and surmounting the problem through the prior art, in the present utility model, based on the practical experiences and long term study by the inventor of this utility model, the approaches of using different solvents to prepare the electrode of Li battery were proposed in this utility model to solve the above mentioned problems.

### SUMMARY OF THE INVENTION

In the device and component recorded in the full text of this utility model, the measure word of “a” or “one” has been used, and it is only for convenience purpose and for providing the general meaning of the scope of this utility model; in this utility model, it should be read as “comprising one or at least one”, and the singular concept should also include plural situation, unless it significantly has other meaning.

The main purpose of this utility model is to provide an improved electrode structure, which uses low toxicity environmentally friendly solvent to prepare a structure of electrode for Li battery; it has solved the problems of slurry solvent (NP) of electrode of Li battery of prior art, for example, the prior art is expensive, it could easily lead to hazard to environment and human body, in addition, the solvent is of high water absorption, and free amine could be easily generated due to production or recycling, which in turn leads to instability of the battery.

More specifically speaking, technologies included in this utility model are: an electrode material, and the electrode material includes lithium nickel cobalt manganese oxide (NMC), Lithium iron phosphate (LFP), Lithium Manganese Iron Phosphate (LMFP), lithium nickel cobalt aluminum oxide(NCA), silicon oxide carbon composite material (SiOx/C), silicon carbon composite material(Si/C), Mesocarbon Microbead(MCMB), Lithium-titanate(LTO), wherein the electrode material has weight percentage of 80-96%; an electrically conductive material, wherein the electrically conductive material contains electrically conductive carbon black(Super-P), Ketjenblack auxiliary conductive agent(KB), carbon nano tube(CNT) and Graphene, wherein the electrically conductive material has weight percentage of 2-10%; an adhesive, wherein the adhesive contains polyvinylidene difluoride(PVDF), Polyvinylidene fluoride-hexafluoropropylene copolymer(PVDF-HFP), Polyimide and polyethylene oxide(PEO), wherein the adhesive has weight percentage of 2-10%; and a low toxicity environmentally friendly solvent, wherein the low toxicity environmentally friendly solvent includes Dimethylformamide(DMF), diethylformamide(DEF), Dimethyl acetamide(DMAC), Tetrahydrofuran(THF), wherein the low toxicity environmentally friendly solvent has chemical formula of

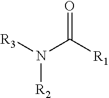

(NR₂R₃OR₁), and R₁═H, Me(-CH₃), R₂═=H, Me(-CH₃), Et(-CH₂CH₃), R₃═H, Me(-CH₃), Et(-CH₂CH₃), wherein the low toxicity environmentally friendly solvent has weight percentage of 20-70% in positive electrode material, and 100-150% in negative electrode material; wherein the improved electrode structure was given with baking temperature of 50-150° C., and process time of 8 to 12 hours.

For technical means to solve the problem, in order to achieve the above objective, an improved electrode structure was provided in this utility model mainly comprising of: an electrode material, wherein the electrode material has weight percentage of 80-96%; an electrically conductive material, wherein the electrically conductive material has weight percentage of 2-10%; an adhesive, wherein the adhesive has weight percentage of 2-10%; and a low toxicity environmentally friendly solvent, wherein the low toxicity environmentally friendly solvent has weight percentage of₂₀-7₀% in positive electrode material, and 100-150% in negative electrode material; wherein the improved electrode structure was given with treatment of baking temperature of 50-150° C., and process time of 8 to 12 hours.

In one embodiment of the present utility model, the electrode material includes lithium nickel cobalt manganese oxide (NMC), Lithium iron phosphate (LFP), Lithium Manganese Iron Phosphate (LMFP), lithium nickel cobalt aluminum oxide(NCA), silicon oxide carbon composite material (SiOx/C), silicon carbon composite material(Si/C), Mesocarbon Microbead(MCMB), Lithium-titanate(LTO).

In further one embodiment of the present utility model, the electrically conductive material includes electrically conductive carbon black(Super-P), Ketjenblack auxiliary conductive agent(KB), carbon nano tube(CNT) and Graphene.

In further one embodiment of the present utility model, the adhesive includes polyvinylidene difluoride(PVDF), Polyvinylidene fluoride-hexafluoropropylene copolymer(PVDF-HFP), Polyimide and polyethylene oxide(PEO).

In further one embodiment of the present utility model, the low toxicity environmentally friendly solvent includes Dimethylformamide(DMF), diethylformamide(DEF), Dimethyl acetamide(DMAC) and Tetrahydrofuran(THF).

In further one embodiment of the present utility model, the low toxicity environmentally friendly solvent has chemical formula of

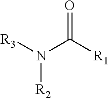

(NR₂R₃OR₁), wherein R₁═H, Me(-CH₃), R₂═=H, Me(-CH₃), Et(-CH₂CH₃), R₃═H, Me(-CH₃), Et(-CH₂CH₃).

In further one embodiment of the present utility model, the low toxicity environmentally friendly solvent has boiling point at one ATM of about 180° C.

In further one embodiment of the present utility model, the low toxicity environmentally friendly solvent has flash point at one ATM of about ≥60° C., 80° C.

In further one embodiment of the present utility model, the electrode material has thickness in the range from 50 μm to 200 μm.

In further one embodiment of the present utility model, the adhesive solution has agitation temperature of 60° C., process time of 0.5 to 6 hours.

Through the above statement, the following advantages can be gained from the present utility model:
1. It can replace the solvent used in the present battery market.
2. It can save the energy consumption needed in drying-recycling process of the battery manufacturing process.
3. It can solve technical issues in slurry solvent (NMP) of electrode of Li battery of the prior art, for example, high cost and its ease to cause hazard to environment and human body.
4. It can solve the easy water absorption characteristic of the solvent and instability in battery due to free amine generated from the manufacturing and recycling process.

### A BRIEF DESCRIPTION OF THE DRAWINGS

FIG. 1 shows the test results of battery stabilities of electrodes made up of different solvents in this utility model;

FIG. 2 shows the chemical formula of low toxicity environmentally friendly solvent N,N-diethylformamide of this utility model;

FIG. 3 is illustration of improved electrode structure of this utility model.

### DETAILED DESCRIPTION OF THE INVENTION

The accompanying attached drawings of this utility model were described in detail as follows in association with embodiment; meanwhile, for the drawings used in the text, they are just for illustrations and assisted description, and they are not necessarily of real proportion and precise deployment after the embodiment of this utility model, therefore, what is claimed in actual embodiment of this utility model should not be limited by the proportion and deployment relationship of the drawings attached.

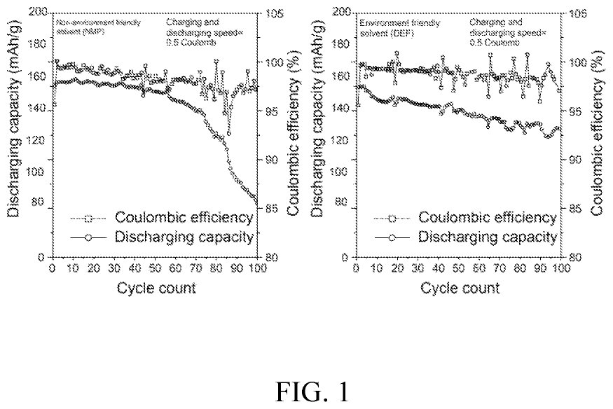

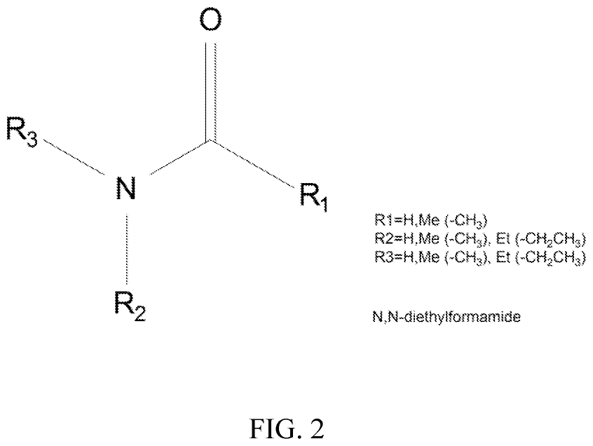

FIG. 1 shows the test results of battery stabilities of electrodes made up of different solvents in this utility model, and FIG. 2 shows the chemical formula of low toxicity environmentally friendly solvent N, N-diethylformamide of this utility model, and

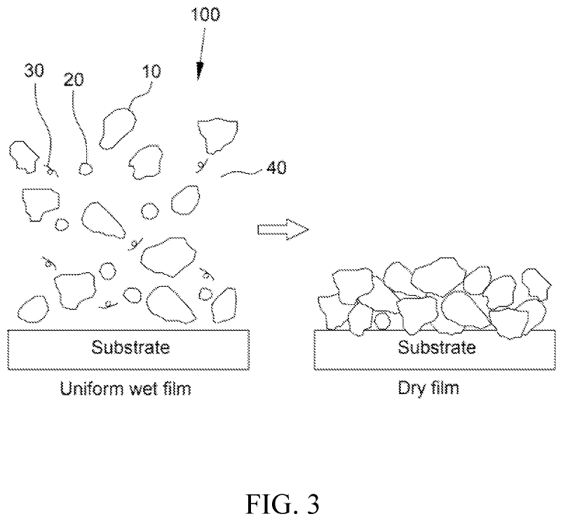

FIG. 3 is illustration of improved electrode structure of this utility model.

The following embodiment is only a better example of this utility model, therefore, it should not be used to limit what is claimed of this utility model. This embodiment is used to describe the preparation of Li ion secondary battery provided by this utility model.

### Embodiment 1

### Preparation of Positive Electrode

Add 3.2 grams of positive electrode active component NMC (LₓNi_{y}Mn_{z}Co_{1-y-z}O₂ (0<x,y,z<1)), 0.4 gram of adhesive polyvinylidene difluoride and 0.4 gram electrically conductive carbon black into 9.6 grams of dimethyl acetamide, then agitate them in ball mill mixer to agitate and form uniform slurry material for positive electrode.

Moreover, the slurry material was uniformly coated on aluminum foil of thickness of 20 um, then it was baked under 120° C., then it was cut to obtain positive electrode of dimension 120×60.0×0.08 mm, then the electrode was rolled, and before the rolling, the rolling gap X between two rollers was adjusted so that X=0.064 mm, in other words, the thickness obtained after rolling was positive electrode of 0.061 mm. And it contains 6.64 mg of active component NMC.

### Embodiment 2

Add 3.2 grams of positive electrode active component LFP (LiFePO₄), 0.4 gram of adhesive polyvinylidene difluoride, 0.4 gram of conductive agent of electrically conductive carbon black into 9.6 grams of dimethyl acetamide, then it was agitated in ball mill mixer to form homogeneous positive electrode slurry material. Moreover, the slurry material was uniformly coated on aluminum foil of thickness 20 um, then it was baked under 120° C., then it was cut into positive electrode of dimension 120×60.0×0.075 mm, next, the electrode was rolled, and before the rolling, adjust the roller gap X between two rollers to let X=0.060 mm, after rolling, positive electrode of thickness 0.058 mm was obtained. And it contains 5.34 mg active component LFP.

Battery assembly Place the above mentioned positive electrode onto the lower cap of button shape Li battery, then drop 30 μl LiPF₆ in the concentration of 1 mole/liter into EC/DEC=1:1 mixed solvent to form the electrolyte, then cover up with Celgard 2325 (PP/PE/PP) diaphragm material, then place in Li metal negative electrode material, then cover up with upper cap and seal it into a button shape Li ion secondary battery; the designed theoretical capacity of prepared NMC Li ion battery of this utility model was of 200 mAh/g, and the designed theoretical capacity of LFP Li ion battery was 170 mAh/g.

### Test PVDF Viscosity Property of Different Solvent

Table 1 shows that different solvents are used to prepare 4 wt % PVDF slurry material, then through rotational viscometer—viscosity tester (Manufactured by Elcometer Corporation of England, with model number Elcometer 2300), the respective viscosity was measured.

TABLE 1
Viscosities of 4 wt % polyvinylidene difluoride(PVDF)
solutions in different solvents

| polyvinylidene | | |
|---|---|---|
| difluoride(PVDF) | Solvent | Viscosity |
| polyvinylidene | Non-environmentally | 1336 |
| difluoride(PVDF) adhesive1 | friendly solvent(NMP) | |
| polyvinylidene | Environmentally | 1114 |
| difluoride(PVDF) adhesive1 | friendly solvent(DEF) | |
| polyvinylidene | Non-environmentally | 843 |
| difluoride(PVDF) adhesive2 | friendly solvent(NMP) | |
| polyvinylidene | Environmentally | 778 |
| difluoride(PVDF) adhesive2 | friendly solvent(DEF) | |

Measure the contact angle of different solvent PVDF on the surface of different foil material.

The contact angle in table 2 was measuredly optical contact angle analysis instrument (Manufactured by Creating Nano Technologies Inc. with model number OCA 40 Micro) for different solvent PVDF slurry material dropped on different foil material.

TABLE 2
Contact angles of polyvinylidene difluoride(PVDF)
solution in different current collectors

| | | Type of current collector | | | |
|---|---|---|---|---|---|
| polyvinylidene | | | Washed | | Washed |
| difluoride | | Al | Al | Cu | Cu |
| (PVDF) | Solvent | foil | foil | foil | foil |
| polyvinylidene | Non- | 38 | 19 | 50 | 42 |
| difluoride | environmentally | | | | |
| (PVDF) | friendly solvent | | | | |
| adhesive 1 | (NMP) | | | | |
| polyvinylidene | Environmentally | 42 | 23 | 55 | 48 |
| difluoride | friendly | | | | |
| (PVDF) | solvent(DEF) | | | | |
| adhesive1 | | | | | |
| polyvinylidene | Non- | 40 | 21 | 53 | 46 |
| difluoride | environmentally | | | | |
| (PVDF) | friendly | | | | |
| adhesive2 | solvent(NMP) | | | | |
| polyvinylidene | Environmentally | 45 | 27 | 57 | 51 |
| difluoride | friendly | | | | |
| (PVDF) | solvent(DEF) | | | | |
| adhesive2 | | | | | |

Table 3 shows the result of battery cycling test for battery assembled by electrodes prepared from non-environmentally friendly solvent (NMP) and environmentally friendly solvent (DEF) of some embodiments in this disclosure. Specifically speaking, the positive and negative material of battery was respectively Li and NMC (LxNiyMnzCo1-y-ZO₂ (0<x,y,z<1)). The above mentioned electrode, diaphragm and electrolyte were assembled into CR2032 button battery under Ar environment, and battery charging and discharging device of model number BAT-750B manufactured by UBIQ Corporation was used for battery cycling test at room temperature.

TABLE 3
The cycling stability test (NMC811//Li) for different solvents when charging and discharging speed was 0.5 Coulombs.

| | 1 time | | 25 times | | 50 times | | 100 times | |
|---|---|---|---|---|---|---|---|---|
| | cycling | | cycling | | cycling | | cycling | |
| | capacity | | capacity | | capacity | | capacity | |
| | (mAh g⁻¹) | | (mAh g⁻¹) | | (mAh g⁻¹) | | (mAh g⁻¹) | |
| Electrode | Charging | Discharging | Charging | Discharging | Charging | Discharging | Charging | Discharging |
| Non-environmentally | 161.4 | 154.2 | 156.3 | 154.5 | 153.6 | 151.3 | 84.1 | 81.8 |
| friendly | | | | | | | | |
| solvent(NMP) | | | | | | | | |
| Environmentally | 161.8 | 154.7 | 144.9 | 144.2 | 140.1 | 139.4 | 133.5 | 130.1 |
| friendly | | | | | | | | |
| solvent(DEF) | | | | | | | | |

As shown in FIG. 1, in one embodiment of this utility model, the electric capacity of electrode prepared from non-environmentally friendly solvent(NMP) decays very fast, for example, at the moment of 100 times of cycling, only 52.10% of the original capacity was left, however, for environmentally friendly solvent(DEF) of this disclosure, at the moment of 100 times of cycling, 82.5% of the original capacity was still left.

Therefore, it can be seen that when environmentally friendly solvent(DEF) of this disclosure is applied in battery, it was clear that due to low water absorption characteristic of low toxicity environmentally friendly solvent and no generation of free amine, it's difficult to lead to the deterioration of electrode, therefore, the battery can be more adaptable to be operated under the environment.

As shown in FIG. 2 and FIG. 3, an improved electrode structure 100 in one embodiment of this utility model mainly comprising of: an electrode material 10, wherein the electrode material 10 includes lithium nickel cobalt manganese oxide (NMC), Lithium iron phosphate (LFP), Lithium Manganese Iron Phosphate (LMFP), lithium nickel cobalt aluminum oxide(NCA), silicon oxide carbon composite material (SiOx/C), silicon carbon composite material(Si/C), Mesocarbon Microbead(MCMB), Lithium-titanate(LTO), wherein the weight percentage of the electrode material 10 was 80-96%; an electrically conductive material 20, wherein the electrically conductive material 20 contains electrically conductive carbon black(Super-P), Ketjenblack auxiliary conductive agent(KB), carbon nano tube(CNT) and Graphene, wherein the weight percentage of the electrically conductive material 20 was 2-10%; an adhesive 30, wherein adhesive 30 includes polyvinylidene difluoride(PVDF), Polyvinylidene fluoride-hexafluoropropylene copolymer(PVDF-HFP), Polyimide and polyethylene oxide(PEO), wherein the weight percentage of the adhesive 30 was 2-10%; and a low toxicity environmentally friendly solvent 40, and the low toxicity environmentally friendly solvent 40 includes Dimethylformamide(DMF), diethylformamide(DEF), Dimethyl acetamide(DMAC), Tetrahydrofuran(THF), and the low toxicity environmentally friendly solvent 40 was N,N-Diethyl formamide (DEF, N,N-diethylformamide), and chemical formula of the low toxicity environmentally friendly solvent 40 was

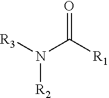

(NR₂R₃OR₁), wherein R₁═H, Me(-CH₃), R₂═=H, Me(-CH₃), Et(-CH₂CH₃), R₃═H, Me(-CH₃), Et(-CH₂CH₃), wherein the weight percentage of the low toxicity environmentally friendly solvent 40 was 20-70% in positive electrode material, and 100-150% in negative electrode material; the low toxicity environmentally friendly solvent 40 has boiling point of ≤180° C. (lower boiling point will reduce the baking temperature and shorten baking time) at 1 ATM; and the flash point of the low toxicity environmentally friendly solvent 40 was ≥60° C., ≤80° C. (When flash point is greater than 60° C., it will not create problem for solvent transport) at 1 ATM; thickness of the electrode material 10 was in the range from 50 μm to 200 μm; and agitation temperature of the adhesive 30 solution≤60° C., process time was 0.5 to 6 hours; and the improved electrode structure 100 was given with treatment of baking temperature of 50-150° C., process time of 8 to 12 hours; wherein the improved electrode structure 100 can be cut into all kinds of shapes (for example, rectangle, rhombus, parallelogram, trapezoid, triangle, circle or irregular shape), then they are winded or stacked and assembled into battery; wherein when the improved electrode structure 100 was assembled into battery, it can be used as battery of mobile phone or power battery of electric vehicle, or other type of battery. Through the above mentioned structure, the improved electrode structure of this utility model has used low toxicity environmentally friendly solvent to prepare Li battery electrode to solve many problems of slurry solvent (NMP) of prior art Li battery electrode, for example, higher cost, technical issues to lead to environment and human body hazard, ease of absorption of water by the solvent, and ease of generation of instability of battery due to free amine generated from manufacturing or recycling, therefore, it can conform to the condition of progress and practicality, and it can also meet the user's need.

The main features of this utility model are: It can replace the solvent used in the present battery market, and it can also save energy consumption in the drying—recycling process during the battery manufacturing process; and it has been applied in Li ion battery field.

To sum up, it is clear that the structure of this utility model was not seen in publication or used in public, therefore, it can conform to the application requirement of a patent, and it is hoped that your esteemed patent office can grant this patent application as early as possible.

What needs to be stated is that the above mentioned is only a specific embodiment of this utility model, that is, the applied technical principle, for any change made based on the concept of this utility model, if its generated function does not exceed the spirit covered by this specification and drawings, it should fall within what is claimed of this utility model.

### DESCRIPTIONS OF SYMBOLS

100: improved electrode structure
10: electrode material
20: electrically conductive material
30: adhesive
40: low toxicity and environmentally friendly solvent

What is claimed is:

1. An improved electrode structure comprising mainly of the following features: an electrode material, wherein the weight percentage of the electrode material is 80-96%; an electrically conductive material, wherein the weight percentage of the electrically conductive material is 2-10%; an adhesive, wherein the weight percentage of the adhesive is 2-10%; a low toxicity environmentally friendly solvent, wherein the weight percentage of the low toxicity environmentally friendly solvent is 20-70% in positive electrode material, and is 100-150% in negative electrode material; wherein the improved electrode structure is given with treatment of baking temperature of 50-150° C., process time of 8 to 12 hours.

2. The improved electrode structure of claim 1 wherein the electrode material includes lithium nickel cobalt manganese oxide (NMC), Lithium iron phosphate (LFP), Lithium Manganese Iron Phosphate (LMFP), lithium nickel cobalt aluminum oxide(NCA), silicon oxide carbon composite material (SiOx/C), silicon carbon composite material(Si/C), Mesocarbon Microbead(MCMB) and Lithium-titanate(LTO).

3. The improved electrode structure of claim 1 wherein the electrically conductive material includes electrically conductive carbon black(Super-P), Ketjenblack auxiliary conductive agent(KB), carbon nano tube(CNT) and Graphene.

4. The improved electrode structure of claim 1 wherein the adhesive includes polyvinylidene difluoride(PVDF), Polyvinylidene fluoride-hexafluoropropylene copolymer(PVDF-HFP), Polyimide and polyethylene oxide(PEO).

5. The improved electrode structure of claim 1 wherein the low toxicity environmentally friendly solvent includes Dimethylformamide(DMF), diethylformamide(DEF), Dimethyl acetamide(DMAC) and Tetrahydrofuran(THF).

6. The improved electrode structure of claim 1 wherein the low toxicity environmentally friendly solvent has chemical formula of 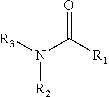
(NR₂R₃OR₁), wherein R₁═H, Me(-CH₃), R₂═=H, Me(-CH₃), Et(-CH₂CH₃), R₃═H, Me(-CH₃), Et(-CH₂CH₃).

7. The improved electrode structure of claim 1 wherein the low toxicity environmentally friendly solvent has boiling point≤180° C. at 1 ATM.

8. The improved electrode structure of claim 1 wherein the low toxicity environmentally friendly solvent has flash point≥60° C., ≤80° C. at 1 ATM.

9. The improved electrode structure of claim 1 wherein the electrode material has thickness in the range from 50 μm to 200 μm.

10. The improved electrode structure of claim 1 wherein the adhesive solution has agitation temperature≤60° C., and process time from 0.5 to 6 hours.
